(19) United States
(12) Patent Application Publication
(10) Pub. No.: US 2025/0220379 A1
(43) Pub. Date: Jul. 3, 2025

(54) Spatial Audio Communication

(71) Applicant: Nokia Technologies Oy, Espoo (FI)

(72) Inventors: Juha Tapio Vilkamo, Helsinki (FI); Mikko-Ville Laitinen, Espoo (FI); Jussi Kalevi Virolainen, Espoo (FI)

(21) Appl. No.: 18/985,256

(22) Filed: Dec. 18, 2024

(30) Foreign Application Priority Data
Dec. 19, 2023 (GB) 2319496.2

(51) Int. Cl. H04S 7/00; H04S 3/00

(52) U.S. Cl. CPC H04S 7/302; H04S 3/008; H04S 2400/01; H04S 2400/11; H04S 2400/15

(57) ABSTRACT

Examples of the disclosure relate to spatial audio communication. An apparatus receives multiple audio signals wherein the multiple audio signals include at least one spatial audio signal. The apparatus obtains information relating to activity of sound sources for at least for the at least one spatial audio signal and enables spatial processing of the at least one spatial audio signal. The spatial processing is based, at least in part, on the obtained activity information and the spatial processing controls the positioning of the sound sources according to the obtained activity information.

### TECHNOLOGICAL FIELD

Examples of the disclosure relate to spatial audio communication. Some relate to spatial audio communication such as teleconferences.

### BACKGROUND

Spatial audio enables spatial properties of sound sources to be rendered so that a listener can perceive different sounds to arrive from different directions. Spatial audio can be used in communications such as teleconferences.

### BRIEF SUMMARY

According to various, but not necessarily all, examples of the disclosure there is provided an apparatus for spatial audio communication comprising means for:

receiving multiple audio signals wherein the multiple audio signals comprise at least one spatial audio signal;

obtaining information relating to activity of sound sources for at least for the at least one spatial audio signal; and

enabling spatial processing of the at least one spatial audio signal based, at least in part, on the obtained activity information wherein the spatial processing controls the positioning of the sound sources according to the obtained activity information.

The spatial processing may control the positioning of one or more active sources.

The activity information may be based on at least one of:
position of active sources in an audio signal;
number of active sources in an audio signal; or
amount of activity of active sources in an audio signal

The spatial processing may comprise at least one of repositioning the at least one spatial audio signal or resizing the at least one spatial audio signal.

The spatial processing may resize at least one spatial audio signal so that an audio signal with more activity from sound sources has a larger size than an audio signal with less activity from sound sources.

The spatial processing may comprise applying a weighting factor to one or more spatial audio signals and resizing the spatial audio signals based on the weighting factor wherein the weighting factor is based, at least in part, on the activity information.

The resizing of the spatial audio signal may change an angular span of the audio signal.

The repositioning of the spatial audio signal may change a distance of the audio signal.

The spatial processing may comprise repositioning of the obtained at least one spatial audio signal so that a first audio signal is positioned in a first direction and a second audio signal is positioned in a second direction.

The spatial processing may comprise repositioning of the obtained at least one spatial audio signal so that an audio signal with more activity from sound sources is in a more prominent position than an audio signal with less activity from sound sources.

The means may be for combining the multiple audio signals after the spatial processing.

The multiple audio signals may comprise at least one mono audio signal.

The spatial processing may comprise assigning a position to the at least one mono audio signal.

The multiple audio signals may comprise a first audio signal captured from a first audio scene and a second audio signal captured from a second audio scene.

The spatial audio signal may comprise at least one of:
stereo;
multi-channel
ambisonics;
parametric spatial audio.

The multiple audio signals may be received via multiple channels.

According to various, but not necessarily all, examples of the disclosure there may be provided a teleconference system comprising one or more apparatus as described herein.

According to various, but not necessarily all, examples of the disclosure there may be provided a method comprising:
receiving multiple audio signals wherein the multiple audio signals comprise at least one spatial audio signal;
obtaining information relating to activity of sound sources for at least for the at least one spatial audio signal; and
enabling spatial processing of the at least one spatial audio signal based, at least in part, on the obtained activity information wherein the spatial processing controls the positioning of the sound sources according to the obtained activity information.

According to various, but not necessarily all, examples of the disclosure there may be provided a computer program comprising instructions which, when executed by an apparatus, cause the apparatus to perform at least:
receiving multiple audio signals wherein the multiple audio signals comprise at least one spatial audio signal;
obtaining information relating to activity of sound sources for at least for the at least one spatial audio signal; and
enabling spatial processing of the at least one spatial audio signal based, at least in part, on the obtained activity information wherein the spatial processing controls the positioning of the sound sources according to the obtained activity information.

According to various, but not necessarily all, examples of the disclosure there may be provided an apparatus comprising: at least one processor 902; and at least one memory 904 storing instructions that, when executed by the at least one processor 902, cause an apparatus 900 at least to perform:
receiving multiple audio signals wherein the multiple audio signals comprise at least one spatial audio signal;
obtaining information relating to activity of sound sources for at least for the at least one spatial audio signal; and
enabling spatial processing of the at least one spatial audio signal based, at least in part, on the obtained activity information wherein the spatial processing controls the positioning of the sound sources according to the obtained activity information.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

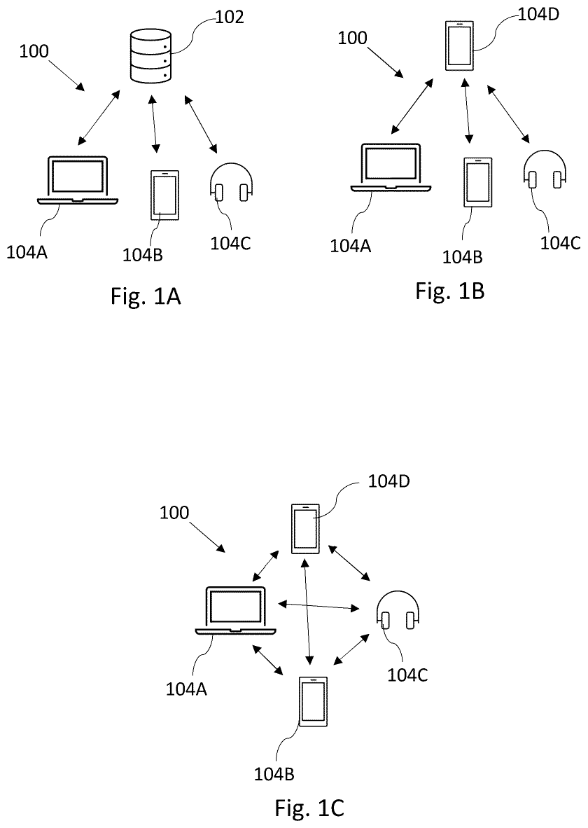

FIGS. 1A to 1C show example systems;

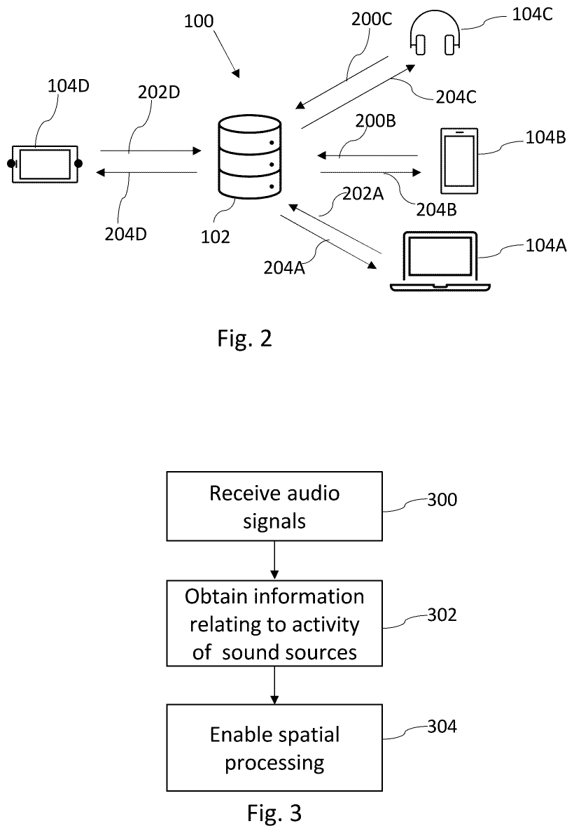

FIG. 2 shows an example system;

FIG. 3 shows an example method;

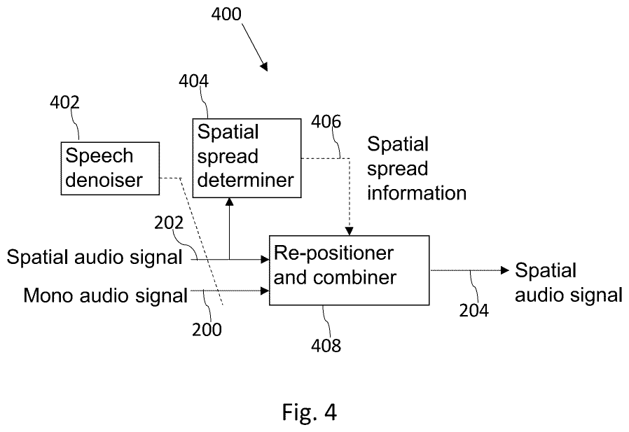

FIG. 4 shows an example spatial audio mixer;

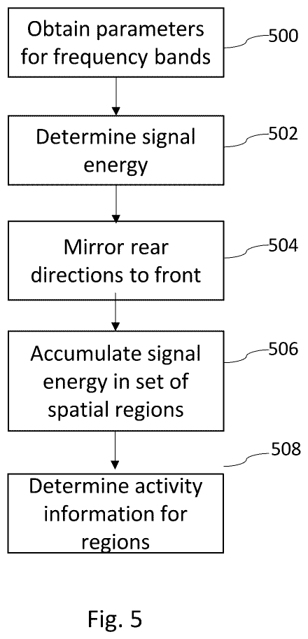

FIG. 5 shows an example method;

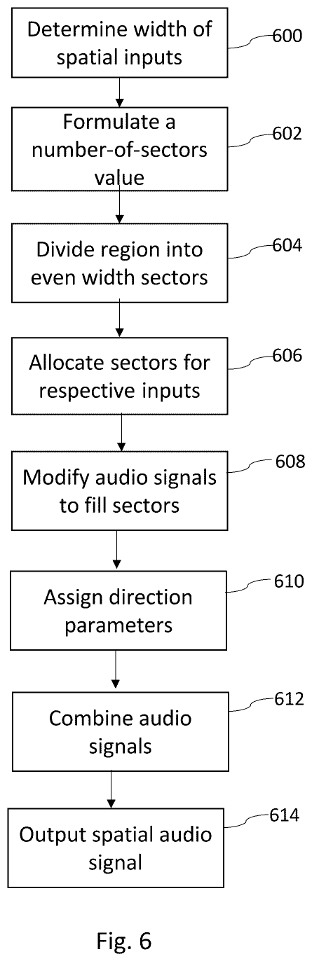

FIG. 6 shows an example method;

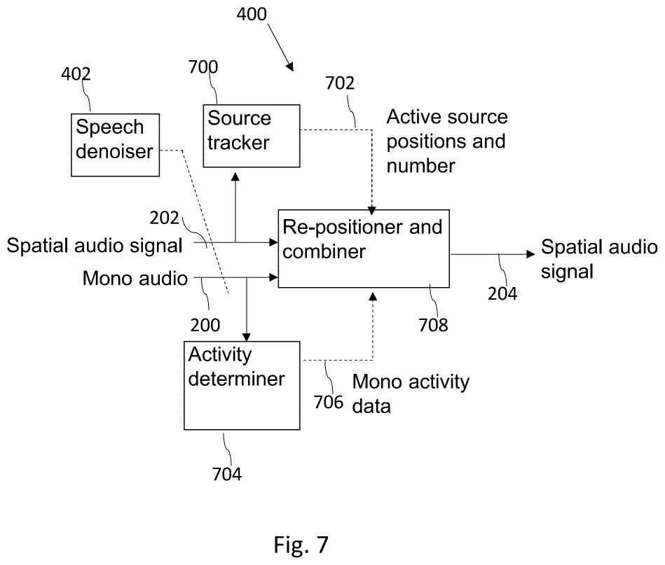

FIG. 7 shows an example spatial audio mixer;

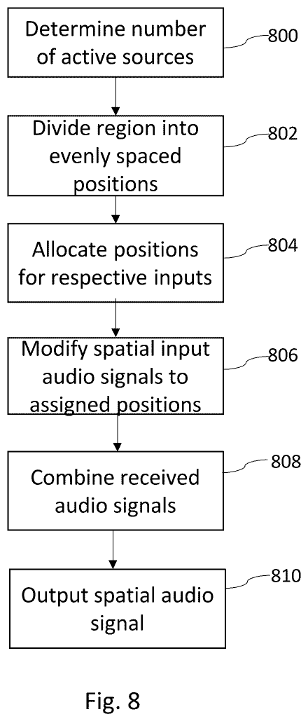

FIG. 8 shows an example method; and

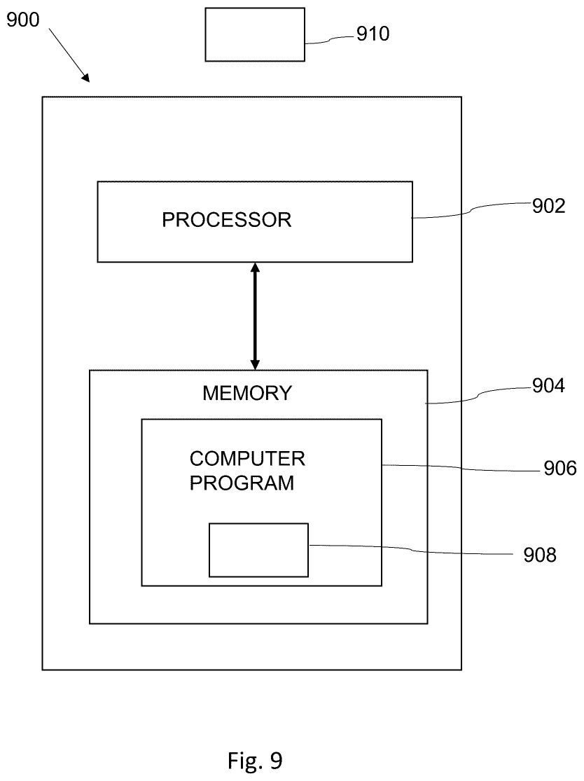

FIG. 9 shows an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

FIGS. 1A to 1C show systems 100 that can be used to implement examples of the disclosure. In these examples the systems 100 are teleconferencing systems. The teleconferencing systems can enable speech, or other similar audio content, to be exchanged between different client devices 104 within the system 100. Other types of audio content can be shared between the respective devices in other examples.

In the example of FIG. 1A the system 100 comprises a server 102 and multiple client devices 104. The server 102 can be a centralized server that provides communication between the respective client devices 104.

In the example of FIG. 1A three client devices 104 are shown. The system 100 could comprise any number of client devices 104 in implementations of the disclosure. The client devices 104 can be used by participants in a teleconference, or other communication session, to listen to audio. The audio can comprise speech or any other suitable type of audio content or combinations of types of audio.

The client devices 104 comprise means for capturing audio. The means for capturing audio can comprise one or more microphones. The user devices 104 also comprise means for playing back audio to a participant. The means for playing back audio to a participant can comprise one or more loudspeakers. In FIG. 1A a first client device 104A is a laptop computer, a second client device 104B is a smart phone and a third client device 104C is a headset. Other types, or combinations of types, of client devices 104 could be used in other examples.

During a teleconference, the respective client devices 104 send data to the central server 102. This data can comprise audio captured by the one or more microphones of the client devices 104. The server 102 then combines and processes the received data and sends appropriate data to each of the client devices 104. The data sent to the client devices 104 can be played back to the participants.

FIG. 1B shows a different system 100. In this system 100 a client device 104D acts as a server and provides the communication between the other client devices 104A-C. In this example the system 100 does not comprise a server 102 because the client device 104D performs the function of the server 102.

In this example the client device 104D that performs the function of the server 102 is a smart phone. Other types of client device 104 could be used to perform the functions of the server 102 in other examples.

FIG. 1C shows another different system 100 in which the respective client devices 104 communicate directly with each other in a peer-to-peer network. In this example, the system 100 does not comprise a server 102 because the respective client devices 104 communicate directly with each other.

Other arrangements for the system 100 could be used in other examples.

The example systems 100 of FIGS. 1A-C can be used to positions and combine multiple audio streams in a spatial call or spatial teleconference. This combining can occur in a server 102 or in a client device 104, depending on the arrangement of the system 100.

The transmission of the audio signals in the example systems 100 can use data encoding, decoding, multiplexing, and demultiplexing. For example, audio signals can be encoded in various ways (such as Advanced Audio Coding (AAC) or Enhanced Voice Services (EVS)) to optimize the bit rate. Similarly, control data, spatial metadata or any similar data can also be encoded. Immersive Voice and Audio Services (IVAS) is an example codec that can be used to encode both the audio signals and the corresponding spatial metadata. Furthermore, the different encoded signals can be multiplexed into one or more combined bit stream. The different encoded systems can also be encoded in a joint fashion so that the features of one signal type affects the encoding of another. An example of this would be that the activity of an audio signal would affect the bit allocation for any corresponding spatial metadata encoder. When encoding and/or multiplexing has taken place at one device sending data, the receiving device then applies the corresponding decoding and demultiplexing.

FIG. 2 shows another example system 100 that can be used to implement examples of the disclosure. This system 100 comprises a server 102 connected to multiple client devices 104 so as to enable a communications session such as a teleconference between the respective client devices 104.

The server 102 can be a spatial teleconference server. The spatial teleconference server 102 is configured to receive input audio signals from the respective client devices 104A-D. The server 102 processes the input audio signals to generate output spatial audio signals 204A-D. The output spatial audio signals 204A-D can then be transmitted to the respective client devices 104A-D.

In the example of FIG. 2 the system comprises four client devices 104A-D. The first client device 104A comprise a laptop, the second client device 104B comprises a smart phone, the third client device 104C comprises a head set, and the fourth client device 104D comprises a smart phone. Other types, or combinations of types, of client devices 104 could be used in other examples.

In the example system 100 shown in FIG. 2 some of the client devices 104 provide input mono audio signals 200 to the server 102. In the example of FIG. 2 the second client device 104B and the third client device 104C send input mono audio signals 200B, 200C to the server 102 and the first client device 104A and the fourth client device 104D send input spatial audio signals 202A, 202D to the server 102. Other arrangements for the input audio signals can be used in other examples.

The spatial audio signals 202, 204 can be any audio signals that are not mono audio signals 200. The spatial audio signals 202, 204 can enable a participant to perceive spatial properties of the audio content. The spatial properties could comprise a direction for one or more sound sources. In some examples the spatial audio signals 202, 204 can comprise stereo signals, binaural signals, multi-channel signals, ambisonics signals, parametric spatial audio streams such as metadata-assisted spatial audio (MASA) signals or any other suitable type of signal. MASA signals or any other suitable type of parametric audio streams, can comprise one or more transport audio signals and associated spatial metadata. The metadata can be used by the client devices 104A-D to render a spatial audio output of any suitable kind based on the transport audio signals. For example, the client devices 104A-D can use the metadata to process the transport audio signals to generate a binaural or surround signal.

The server 102 can be configured to merge the received input audio signals 200, 202. The server 102 can comprise a spatial audio mixer configured to merge the received input audio signals 200, 202. Examples of a spatial audio mixer are shown in FIGS. 4 and 7. Any suitable processes can be used to merge the signals. The server 102 can be configured to merge the received input audio signals 200, 202 to provide unique output spatial audio signals 204 for each of the client devices 104. For instance, the server 102 can receive the input audio signals 200, 202 and combine them so that each input audio signal 200, 202 represents a sector in an output spatial audio signal 204 that can be provided to a client device 104.

In the example of FIG. 2 the server 102 performs the processing and spatial positioning of the input audio signals 200, 202. In other examples the server 102 can control other devices, such as the client device 104 to perform the spatial positioning

FIG. 3 shows an example method that can be used in examples of the disclosure. The method could be implemented using teleconferencing systems such as the systems 100 shown in FIGS. 1A to 1C and FIG. 2. The method can be implemented using any suitable apparatus. The apparatus could be in a server 102 or a client device 104 or any other suitable electronic device. FIG. 9 schematically shows an example apparatus that could be used in some examples.

At block 300 the method comprises receiving multiple audio signals wherein the multiple audio signals comprise at least one spatial audio signal. The spatial audio signals can comprise any audio signals that are not mono audio signals. The spatial audio signals can comprise stereo, multi-channel, ambisonics, parametric spatial audio or any other suitable type of audio signal. One or more mono audio signals can also be received with the at least one spatial audio signal.

The multiple audio signals can comprise a first audio signal captured from a first audio scene and a second audio signal captured from a second audio scene. The multiple audio signals can be received via multiple channels. The multiple audio signals can be received from multiple client devices 104.

At block 302 the method comprises obtaining information relating to activity of sound sources at least for the at least one spatial audio signal. The information relating to the activity of sound sources can be obtained for one spatial audio signal or for multiple spatial audio signals.

The activity information can be related to how active an audio signal is in a communication session. This could relate to the number of sound sources within the audio signals. For instance, if the sound sources are people talking then the activity information can relate to the amount of talking within an audio signal.

In some examples the activity information can be obtained for multiple spatial audio signals. In some examples the activity information can be obtained for just one spatial audio signal.

The activity information can be based on position of active sources in an audio signal, number of active sources in an audio signal, amount of activity of active sources in an audio signal, or any other suitable information. The active sources can be people talking or any other suitable type of sound sources.

At block 304 the method comprises enabling spatial processing of the at least one spatial audio signal. The spatial processing of the at least one spatial audio signal is based, at least in part, on the obtained activity information and controls the positioning of the sound sources according to the obtained activity information.

The spatial processing can control the positioning of one or more active sources. The active sources can be sound sources that have been identified as being active in the activity information.

The spatial processing can comprise at least one of repositioning the at least one spatial audio signal or resizing the at least one spatial audio signal. In some examples the spatial processing resizes at least one spatial audio signal so that an audio signal with more activity from sound sources has a larger size than an audio signal with less activity from sound sources.

If the received multiple audio signals comprise one or more mono audio signals then the spatial processing can comprise assigning a position to the at least one mono audio signal.

In some examples the spatial processing can comprise applying a weighting factor to one or more spatial audio signals and resizing the spatial audio signals based on the weighting factor. The weighting factor can be based, at least in part, on the activity information. For instance, if the activity information indicates a higher level of activity then the weighting factor can be used to resize the spatial audio signal so that it is larger than other audio signals. If the activity information indicates a lower level of activity then the weighting factor can be used to resize the spatial audio signal so that it is smaller than other audio signals.

In some examples the resizing of the spatial audio signal changes an angular span of the audio signal. For example, angular sectors can be allocated to the respective audio signals and the angular span of the audio signals can be controlled by the spatial processing.

In some examples the repositioning of a spatial audio signal changes a distance of the audio signal. In some examples the resizing of a spatial audio signal changes a depth of the audio signal.

In some examples the spatial processing can comprise repositioning of the obtained at least one spatial audio signal so that a first audio signal is positioned in a first direction and a second audio signal is positioned in a second direction.

In some examples the spatial processing can comprise repositioning of the obtained at least one spatial audio signal so that an audio signal with more activity from sound sources is in a more prominent position than an audio signal with less activity from sound sources. For instance, the audio signals comprising the most active sound sources could be repositioned to the front while audio signals comprising less active sound sources can be repositioned to the side.

In some examples the method can comprise additional blocks that are not shown in FIG. 3. For example, the method can comprise combining the multiple audio signals after the spatial processing.

Examples of the disclosure therefore provide for systems 100 and apparatus that can be used to control the positioning of participants within a spatial communication session. The positioning can be controlled to improve the perceptibility and audio quality of the respective audio signals for a listener. For example, by providing larger sectors to audio signals comprising more active sources it can improve the intelligibility of the respective sources within such audio signals.

FIG. 4 shows an example spatial audio mixer 400 that could be used in examples of the disclosure.

The spatial audio mixer 400 receives multiple audio signals as an input. The audio signals can comprise one or more spatial audio signals 202. In this example the input audio signals also comprise one or more mono audio signals 200. The one or more spatial audio signals 202 and one or more mono audio signals 200 can be received from client devices 104. In the example of FIG. 4 the input audio signals can comprise both spatial audio signals 202 and mono audio signals 200. In other examples the input audio signals could comprise only spatial audio signals 202.

The spatial audio mixer 400 is shown preparing a spatial audio output signal 204 for a single client device, for example the first client device 104A. The spatial audio mixer 400 can also prepare a corresponding spatial audio output signal 204 for the other client devices 104 in the system 100. The server 102 can also be configured to perform other processing that is not shown in FIG. 4. For example, the server 102 can perform processing related to conveying video streams and/or any other suitable processing.

In the example of FIG. 4 the spatial audio signals can comprise metadata-assisted spatial audio (MASA) signals. These comprise mono or stereo transport audio signals and spatial metadata indicating spatial information such as directions and direct-to-total ratios in frequency bands. The metadata can be in any suitable format. Example of suitable formats are shown in table 1 and table 2. Other types of spatial audio signals could be used in other examples. Other types of spatial audio could be used in other examples such as stereo, Ambisonics or surround audio.

TABLE 1
MASA format spatial metadata parameters
(dependent of number of directions)

| Field | Bits | Description |
|---|---|---|
| Direction index | 16 | Direction of arrival of the sound at a time- |
| | | frequency parameter interval. Spherical |
| | | representation at about 1-degree accuracy. |
| | | Range of values: “covers all directions at |
| | | about 1° accuracy” |
| | | Values stored as 16-bit unsigned integers. |
| Direct-to-total | 8 | Energy ratio for the direction index (i.e., |
| energy ratio | | time-frequency subframe). |
| | | Calculated as energy in direction/total energy. |
| | | Range of values: [0.0, 1.0] |
| | | Values stored as 8-bit unsigned integers with |
| | | uniform spacing of mapped values. |
| Spread coherence | 8 | Spread of energy for the direction index (i.e., |
| | | time-frequency subframe). |
| | | Defines the direction to be reproduced as a |
| | | point source or coherently around the direction. |
| | | Range of values: [0.0, 1.0] |
| | | Values stored as 8-bit unsigned integers with |
| | | uniform spacing of mapped values. |

TABLE 2
MASA format spatial metadata parameters
(independent of number of directions)

| Field | Bits | Description |
|---|---|---|
| Diffuse-to- | 8 | Energy ratio of non-directional sound over |
| total energy | | surrounding directions. |
| ratio | | Calculated as energy of non-directional sound/ |
| | | total energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Surround | 8 | Coherence of the non-directional sound over the |
| coherence | | surrounding directions. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Remainder-to- | 8 | Energy ratio of the remainder (such as |
| total energy | | microphone noise) sound energy to fulfil |
| ratio | | requirement that sum of energy ratios is 1. |
| | | Calculated as energy of remainder sound/total |
| | | energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |

The input audio signals 200, 202 can be processed by a denoiser 402. The denoiser 402 can be configured to remove noise from the input audio signals 200, 202 and preserve wanted sounds such as speech. The denoiser 402 can preserve wanted sounds in their original spatial position. The denoiser 402 can be optional. In other examples the denoising could be performed at the client devices 104.

In other examples there might not be any denoising in the signal path. For example, if one of the client devices 104 is sharing audio content other that speech. The audio content other than speech could be music or any other suitable type of content.

The operation of the denoiser 402 can be dependent upon the type of signal. For a mono audio signal 200 the denoiser 402 can apply any suitable mono denoiser process. For example, the denoising process can comprise transforming the mono audio signal to a time-frequency representation by using a short-time Fourier transform (STFT) or any other suitable transform. A trained machine learning model, or any other suitable program, can be used to determine gains between 0 and 1 for different time-frequency regions to suppress noise from speech. The determined gains can be applied to the signal. The signal can then be converted back to a time-domain signal by means of inverse STFT or any other suitable transform.

For a spatial audio signal 202 the denoiser 402 can apply any suitable spatial denoiser process. For example, a machine learning model, or any other suitable program, can be used to steer an adaptive beamformer towards the sources and suppressing the remaining noise from the beamform signals. The microphone audio signal speech portion can be re-synthesized by multiplying the resulting speech signal with the estimated speech steering vector. These operations can be performed in the STFT domain, or any other suitable domain.

If the spatial audio signal 202 is a metadata-assisted spatial audio signal, then the denoiser 402 can use the same method as used for mono audio signals 400 to suppress the noise in the signals. In addition to this the denoiser 402 would then also modify the spatial metadata so that the ratio parameters are increased when noise is suppressed. For example, if the ratio parameter for a time index n and frequency index k is r_{orig}(k, n), and if the denoiser 402 has determined a suppression gain g(k, n) between 0 and 1 to suppress noise from speech, then the ratio may be modified by

$$r ( k , n ) = \frac{{r}_{o r i g} ( k , n )}{max ( ϵ , {r}_{o r i g} ( k , n ) + ( 1 - {r}_{o r i g} ( k , n ) ) g ( k , n ) )}$$

where ∈ is a small value, e.g., 10⁻⁹. In some examples the frequency resolution of the suppression gain and the ratio metadata may be different. If the suppression gain has higher frequency resolution, then it can be averaged in frequency so that it obtains the same frequency resolution as the ratio parameter, and then this average is used in the above formula. In some examples the metadata is not modified by the denoiser 402.

The spatial audio signals 202 and the mono audio signals 200 are provided as an input to a spatial spread determiner 404. The spatial spread determiner 404 can be configured to determine activity information for the input audio signals 200, 202. In this case the spatial spread determiner 404 can determine the spatial spread of active sources. The active sources can be people talking or any other suitable sources in the audio signals 200, 202. FIG. 5 shows an example method that can be implemented by the spatial spread determiner 404.

The spatial spread determiner 404 provides spatial spread information 406 as an output. Other types of activity information could be used in other examples.

The spatial spread information 406 and the audio signals 200, 202 are provided as inputs to the re-positioner and combiner 408. The re-positioner and combiner 408 is configured to re-position the audio signals 200, 202 to control the position of active sources. This can make the distribution of the active sources more evenly spread in the spatial outputs which can improve the intelligibly of the sound sources for a listener. FIG. 6 shows an example method that can be performed by the re-positioner and combiner 408.

The re-positioner and combiner 408 provide the spatial audio signal 204 as an output. The spatial audio signal 204 can be transmitted to the client device 104.

FIG. 5 shows an example method that can be implemented by the spatial spread determiner 404 in the example of FIG. 4.

At block 500 the method comprises obtaining parameters for frequency bands of the input spatial audio signals 202. The parameters that are obtained can relate to the spatial properties of the spatial audio signals 202. In some examples the parameters that are obtained can comprise a direction parameter and an energy ratio parameter or any other suitable parameters. If the spatial audio signal 202 comprises a parametric spatial audio signal then the parameters can be obtained from the metadata associated with the spatial audio signal 202.

As an example, for a received spatial audio signal 202, the parameters can be denoted azimuth azi(k, n) and a direct-to-total energy ratio r(k, n), where k is the frequency band index and n is the time index. For use cases such as teleconferencing it can be assumed that the sources are predominantly in the horizontal plane, and the elevation parameters, if available, can be discarded.

At block 502 the method comprises determining the signal energy E(k, n) for the input audio signals. The signal energy E(k, n) can be determined with the same resolution with which the spatial metadata is defined.

As an example, the spatial audio signal 202 can be denoted in a Short-Time Fourier Transform (STFT) representation as S(b, n, ch) where b is the frequency bin index (of the time-frequency transform), n is the time index that in this example is of same temporal resolution as the metadata, and ch is the channel index.

For frequency band k the lowest bin can be denoted b_{low}(k) and the highest bin can be denoted b_{high}(k). The energy, assuming two channels, can then be formulated as

$$E ( k , n ) = {\sum }_{c h = 1}^{2} {\sum }_{b = {b}_{l o w} ( k )}^{{b}_{h i g h} ( k )} {\vert S ( b , n , ch ) \vert}^{2}$$

At block 504 the rear directions are mirrored to the front. In this example, the rear values of azi(k, n) are mirrored to the corresponding front directions. For instance, an azi(k, n) value of 150 degrees is converted to 30 degrees. This mirroring is performed because in a teleconferencing system the participants are typically located on the front side of the capture device. This property can be imposed on the positions of other sources for the other blocks of the method.

At block 506 the signal energy in a set of spatial regions is accumulated. The spatial regions can comprise different sectors. The sectors can be of equal sizing. For instance, there may be 18 sectors ranging from 90 to −90 degrees, where each is 10 degrees wide. In such examples the sector energy is given by E_{sec}(k, n, s_{idx}) where s_{idx} is the sector index. It is formulated by

$${E}_{s e c} ( k , n , {s}_{i d x} ) = {E}_{s e c} ( k , n - 1 , {s}_{i d x} ) * α + ( 1 - α ) E ( k , n ) r ( k , n ) f ( a z i ( k , n ) ∈ {s}_{i d x} )$$

where f(azi(k, n)∈s_{idx}) is a function that is 1 if azi(k, n) resides in the sector s_{idx} and 0 otherwise, and a is a forget factor. The forget factor can take any suitable value such as 0.99. The time-frequency domain values can be summed over frequency to obtain broadband values

$${E}_{s e c} ( n , {s}_{i d x} ) = {\sum }_{k} {E}_{s e c} ( k , n , {s}_{i d x} )$$

The summing can take place over the whole frequency range, or over only a certain frequency range. The certain frequency range could be 300-4000 Hz, which is the frequency range where speech energy mostly resides. Any other suitable range could be used in other examples.

In some examples there could be a frequency dependent weighting in which a higher weighting could be applied to some frequency bands. The frequency bands with the higher weighting could be around 300-4000 Hz where speech energy mostly resides, or could be any other suitable frequency range.

At block 508 the activity information for a region can be determined. In this example the activity information can comprise the borders of a sector that comprises all of the sources in the spatial audio signal. This can be achieved, for example, by selecting the leftmost and rightmost peak in the sector energy data E_{sec}(n, s_{idx}) and setting these as the sector borders. These sector borders provide the spatial spread information that is provided as an output from the spatial spread determiner.

Other methods for determining the spatial spread information 406, or other activity information, can be used in other examples. For instance, some methods could track moving sources.

The spatial spread information 406 or other activity information can be provided as an input to the re-positioner and combiner 408.

FIG. 6 shows an example method that can be performed by the re-positioner and combiner 408 in the example of FIG. 4. The re-positioner and combiner 408 receives the spatial audio signals 202 and the mono audio signals 200 as inputs and also the spatial spread information 406 that has been determined for the input signals. The re-positioner and combiner 408 is configured to create a spatial audio signal 204 that can be output to a client device 104. The output spatial audio signal 204 can be in any suitable format. In some examples the output spatial audio signal 204 can be in a form that spans the front area from 90 to −90 degrees and distributes the different received signals within.

At block 600 the method comprises determining a width for each spatial audio input. In some examples determining a width can comprise determining a spatial audio input is wide or narrow. This can be determined using the spatial spread information 406. As an example, if the sector spans more than 20 degrees (or any other threshold value), the spatial audio input 202 can be considered to be wide. Otherwise to the spatial audio input 202 is determined to be narrow.

At block 602 a number-of-sectors value Nᵢₙ is determined. The number-of-sectors value Nᵢₙ is the sum of the numbers of mono audio inputs 200 and spatial audio inputs 202 where the number of wide spatial audio inputs is weighted by a value. The weighting value can take any suitable value. In this example the weighting value is 3. Other values can be used in other examples. As an example, if there were three mono audio inputs 200, and two spatial audio inputs 202, where only one of them is considered wide, then

$${N}_{i n} = {\underbrace{( 1 + 1 + 1 )}}_{mono audio inputs} + {\underbrace{( 1 + 3 )}}_{spatial audio inputs} = 7.$$

At block 604 the region is divided into Nᵢₙ sectors. The region in this case is the front hemisphere. The regions can be of even width. For example, if Nᵢₙ=18 then one sector width is 10 degrees.

At block 606 sectors are allocated for respective inputs. Multiple consecutive sectors can be allocated for wide spatial inputs. The number of consecutive sectors that can be allocated to a wide spatial input can be linked to the weighting value. In this case the weighting value is 3 and the 3 consecutive sectors are allocated for each wide spatial input. A single sector can be allocated for any narrow inputs. A single sector can also be allocated for any mono audio signals 204.

The audio signals can be allocated to sectors in any suitable order. In some examples the audio signals can be allocated to sectors at random. In other examples some audio signals can be allocated more prominent sectors. For instance, if an audio signal is known to correspond to a key presenter in a teleconference, then this could be given a higher priority than other audio signals and could be allocated one or more sectors towards the center of the region.

At block 608 the audio signals can be modified to fill the respective allocated sectors. The spatial spread information 406 and/or any other suitable activity information can be used to modify the audio signals. For instance, the spatial spread information 406 indicates how the sound sources within the audio signal are distributed. The modifying of the audio signals can therefore comprise modifying the spatial metadata so that the original left-border sounds and anything further left to it are placed to the new assigned left sector edge, and correspondingly for the right directions, and any sounds in between are mapped to directions between the sector edges.

The modifying of the audio signals can also comprise modifying the energy parameters so that that narrower sectors lead to higher energy ratio values.

At block 610 the method comprises assigning direction parameters to the any received mono audio signals 200. The direction that is assigned to the mono audio signal can be the direction of the sector that the received mono audio signal 200 has been allocated. The mono audio signals 200 are therefore assigned to be audio objects at particular directions.

At block 612 the method comprises combining the mono audio signals (now object audio signals) and the modified spatial audio signals. Any suitable process for combining the audio signals can be used.

At block 614 the re-positioner and combiner 408 provides the spatial audio signal 204 as an output. This can be the output of the spatial audio mixer 400 and can be transmitted to the corresponding client device 104.

FIG. 7 shows another example spatial audio mixer 400 that can be used in some examples of the disclosure. Corresponding reference numerals are used for features corresponding to those in FIG. 4.

In the example of FIG. 4 the spatial audio mixer 400 detects the spatial spread of sounds within the spatial audio signals 202 and then repositions them to new sectors. In the example of FIG. 7 the spatial audio mixer 400 performs adaptation of sector widths so that audio signals that are estimated to comprise a higher number of active sources are allocated wider sectors than audio signals that are estimated to comprise a lower number of active sources.

The spatial audio mixer 400 receives multiple audio signals as an input. The audio signals can comprise one or more spatial audio signals 202. In this example the input audio signals also comprise one or more mono audio signals 200. The one or more spatial audio signals 202 and one or more mono audio signals 200 can be received from client devices 104. In the example of FIG. 7 the input audio signals can comprise both spatial audio signals 202 and mono audio signals 200. In other examples the input audio signals could comprise only spatial audio signals 202. The spatial audio signals 202 can comprise any suitable type of audio signals.

The input audio signals 200, 202 can be processed by a denoiser 402. The denoiser 402 can be configured to remove noise from the input audio signals 200, 202 and preserve wanted sounds such as speech. The denoiser 402 can preserve wanted sounds in their original spatial position. The denoiser 402 can be optional. In other examples the denoising could be performed at the client devices 104.

The denoiser can use any suitable denoising processes such as those described above in relation to FIG. 4.

In some examples the spatial audio mixer 400 can also be configured to perform other pre-processing steps. For example, the spatial audio mixer 400 can be configured to mirror any rear azimuth directions of the received spatial audio signals to the front, and/or any elevation data can be discarded.

The spatial audio signals 202 are provided as an input to a source tracker 700. The source tracker 700 can be configured to provide estimates for source direction based on the input spatial audio signals 202. The source tracker 700 can be configured to determine activity information for the input audio signals 200, 202. In the example of FIG. 7 the source tracker 700 can determine the number of active sources and their corresponding directions. The source tracker 700 can use any suitable process to determine the number of active sources and their corresponding directions. For example, the source tracker 700 can inspect estimated sector energy data to determine the peaks that have a level above a threshold.

The source tracker 700 provides active source position and number information 702 as an output. Other types of activity information could be used in other examples.

The active source position and number information 702 can comprise the source directions aziₛ(iₛ, j) for 1≤iₛ≤N_{s,j} where N_{s,j} is the number of sources deemed active for this spatial audio signal (where j is the index of the input stream). The process is performed for each parametric spatial audio signal 202 separately.

In the spatial audio mixer 700 of FIG. 7 the mono audio signals 200 are provided as an input to an activity determiner 704. The activity determiner 704 can be configured to determine the activity of sources within the spatial audio signals 202 and the mono audio signals 200. For example, the activity determiner 704 can be configured to determine if a source has been active over a defined time period. A source can be determined to be active if the source levels are over a threshold for a defined time period. The time period could be the last 60 seconds or any other suitable time period.

The activity determiner 704 provides mono activity data 706 as an output. Other types of activity information could be used in other examples.

The mono activity data 706 can be in any suitable form. In some examples the mono activity data 706 can comprise the number of active sources N_{s,j}, where the values are either 0 or 1 for mono inputs. The input stream index j is for all input signal types, that is, for the mono audio signals 200 and also the spatial audio signals 204.

The active source position and number information 702, the mono activity data 706, and the audio signals 200, 202 are provided as inputs to the re-positioner and combiner 708. The re-positioner and combiner 708 is configured to re-position the audio signals 200, 202 to control the position of active sources. This can make the distribution of the active sources more evenly spread in the spatial outputs which can improve the intelligibly of the sound sources for a listener. FIG. 8 shows an example method that can be performed by the re-positioner and combiner 708.

The re-positioner and combiner 708 provide the spatial audio signal 204 as an output. The spatial audio signal 204 can be transmitted to the client device 104.

FIG. 8 shows an example method that can be implemented by the re-positioner and combiner 708 in the example of FIG. 7.

At block 800 the method comprises determining the number of active sources in the input signals 200, 202. The number of active sources can be determined by summing the values of the number of active sources Ns, for each of the received spatial audio signals 202 (this information can be comprised in active source position and number information 702) and summing to this number the number of mono inputs where the source has been indicated active (this information can be comprised in the mono activity data 706). For example,

$${N}_{t o t a l} = {\sum }_{j} {N}_{S , j}$$

At block 802 the method comprises dividing the region into evenly spaced positions. The region in this case is the front hemisphere comprising the front directions from −90 to 90 degrees to spatially even positions, where the number of the positions is the total number of active sources. For example, if there were 19 positions determined, the division would be to positions that are 10 degrees apart.

At block 804 the positions are allocated to the respective input audio signals. Each of the spatial audio signals 202 are allocated N_{s,j} consecutive positions. The value of N_{s,j} can be different for different spatial audio signals 202. The value of N_{s,j} can be zero for one or more of the input spatial audio signals 202. A position can also be allocated for each mono audio signal that has been indicated to be active.

The audio signals can be allocated to positions in any suitable order. In some examples the audio signals can be allocated to positions at random. In other examples some audio signals can be allocated more prominent positions. For instance, if an audio signal is known to correspond to a key presenter in a teleconference, then this could be given a higher priority than other audio signals and could be allocated positions towards the center of the region.

At block 806 the audio signals can be modified to be positioned at their respective allocated positions. The spatial audio signals can be modified so that they match their assigned positioning. For example, the respective spatial audio signals 202 can be allocated with N_{s,j} consecutive and evenly spaced positions, whereas the original source positions were at aziₛ(iₛ, j). At block 806 the task is therefore to modify the metadata of the spatial audio signal by a function so that positions aziₛ(iₛ, j) map to the allocated new positions. This is done so that the leftmost aziₛ(iₛ, j) maps to the leftmost of the allocated position, second-left to the second-left, and similarly for the other directions/positions. Any metadata positions in between can be mapped in between the corresponding target positions. The ratio parameters can also be modified by considering the allocated position edges as the sector edges.

At block 808 the method comprises combining the mono audio signals (now object audio signals) and the modified spatial audio signals. Any suitable process for combining the audio signals can be used.

Any mono audio signals 200 where no active sources were identified, or spatial audio signals 202 where no sound sources 202 were identified, can be considered in the combining processing as mono sound sources positioned at the front (or in any other suitable direction). This can account for any estimation errors of active talkers.

At block 810 the re-positioner and combiner 708 provides the spatial audio signal 204 as an output. This can be the output of the spatial audio mixer 400 and can be transmitted to the corresponding client device 104.

The example methods of FIGS. 6 and 8 consider the modifying of the parametric spatial audio signal in terms of modifying the spatial metadata. When the spatial metadata is modified then typically the transport audio signals are also modified. Any suitable process can be used to modify the transport audio signals when reproducing a spatial audio signal as a sector.

During a communication session such as a teleconference some participants might be more active than others. For instance, some participants will talk more than the others.

Therefore, the width of a sector allocated to a spatial audio signal 202 may change during the communication session. At the beginning of the communication session, before any activity has been detected a narrow sector can be used for the spatial audio signals 202. Later, during the communication session, it can be determined that there are several active talkers in the spatial audio signals. In such circumstances a wider sector will be allocated for this spatial audio signal 202. If, at another time during the communication session, the sources within this location become inactive, the sector can shrink from a wide one back to a narrow one all during the same communication session.

In some examples when the activity of a sound source of a spatial audio signals 202 changes during a communication session the size of the sector allocated to the spatial audio signal 202 can change but the order in which the spatial audio signals 202 are arranged does not change. This would prevent the positions of the audio signals 202 swapping during the communication session which could be disturbing or confusing for a listener. In other examples the positions and the sizes of the locations of the audio signals could be changed. This could allow for swapping of positions for respective audio signals 202.

In the foregoing examples, the spatial audio input signal 202 was a parametric spatial audio signal. In other examples, the spatial audio signal 202 can be in a different format, such as stereo, multi-channel, Ambisonics, or any other suitable format. For example, if the received spatial audio signal 202 is stereo, then the positions of the active sources within the spatial audio signal 202 can be detected by evaluating to which positions the active sources have been amplitude panned. In some examples this can be performed by determining the directions of time-frequency tiles and then determining the directions of the active sources.

The stereo signal could then be processed to a desired sector, for example, by first re-panning the signal so that the active sources within the stereo sound attain maximum spacing, and then, positioning the two channels to the left and right edges of the targeted sector. Any suitable methods can be used to re-pan the stereo signal.

If the received spatial audio signal is Ambisonics, then the Ambisonics signal can be converted to a parametric spatial audio signal. Any suitable method can be used to convert the Ambisonics signal to a parametric spatial audio signal. For instance, the metadata can be estimated using methods known from Directional Audio Coding (DirAC) and generating the audio signals, the audio signals can be generated as two cardioid signals towards left and right or in any other form. The aforementioned methods can then be used on the generated parametric spatial audio signal.

In the foregoing examples the output of the spatial audio mixer was a parametric spatial audio signal 204. Other types of spatial audio signal 204 could be used in other examples, such as, a stereo signal, a binaural audio signal, a multi-channel audio signal or an Ambisonic signal, or any other suitable type of signal. The respective types of spatial audio signals can be generated by using different panning rules or head-related transfer function (HRTF) processing when positioning the received spatial audio signals 202.

In the foregoing examples, the speech denoiser 402 was always active, and all other sounds than speech (or other wanted sounds) were therefore removed. However, in some circumstances there might be some other wanted sounds such as music. These other wanted sounds can be bypassed from the re-positioning processing and can be conveyed as a conventional stereo signal to the client devices 104. Such signals could be conveyed as an additional audio stream separate stream from the spatial audio signal 204 containing speech. In other examples, the speech signals and the other wanted sounds can be mixed to the same stereo signal via amplitude panning or binaural processing or by any other suitable processes.

In some examples it might be possible to re-positions and resize the other sounds in a similar manner to that used for the speech as described above. For example, the spatial spread of the other wanted sounds (such as music) can be determined as described above, and the rest of the processing can also be as described above.

In some examples, a participant in the communication session can choose between different settings for the communication session. The different settings can enable different distributions of sound sources based on their activity. For example, one setting can be such that the most active sources are positioned to the center stage, and others to the side. Another setting can be such that the most active sources are positioned with maximum spacing with respect to each other, and other sources are positioned in between.

In some communication sessions the number of participants can change over time. For example, the number of client devices 104 sending audio signals to the server 102 in the example systems can change due to participants joining and/or leaving the teleconference or for any other reason. The spatial processing of the audio signals may need to be adapted due to the change in the number of participants. For example, the repositioning and/or resizing might be adjusted. If a new participant joins a communication session then resizing and/or repositioning methods (such as those shown in FIGS. 6 and 8) can be re-triggered to position the new participant to a suitable position. Also, in some cases the audio signals from a participant could switch between a mono audio signal 200 and a spatial audio signal 204 during a communication session. In such cases the re-allocation of positions and/or sectors may be performed.

To avoid abrupt changes, any panning rules and spatial metadata modification rules can be interpolated to the new values over a certain period of time, for example, during 10 seconds. For example, if a spatial sound input is re-positioned to a sector with edges at certain positions, the sector edges can be moved slowly to their new positions.

In some examples, instead of using source tracking methods in the server 102, the server 102 can receive the data (such as the number of talkers, the talker positions) from a client device 102 as metadata along with the audio signals 200, 202. The client device 104 can use more effective source tracking methods, such as, using beamforming techniques, because the original microphone signals are available to the client device 104.

In some examples different spatial processing can be used different types of audio signals content. That is, the repositioning and resizing of the audio signals can be dependent upon the type of audio content. For instance, if the spatial audio signal 202 comprises content such as music or other non-speech content then a wider sector can be allocated to that audio signal. In some examples, if the spatial audio signal 202 comprises mainly speech, a default sector width can be used.

In some examples the server 102 can obtain information of how many participants are joining the conference session from the same acoustic space from which audio is captured and transmitted in spatial audio signals 202 to the server 102. The number of participants can be used as an initial information to define how many adjacent sectors are to be allocated for this spatial audio signal 202 in the beginning of the communication session, when the source activity information is not yet available. The number of participants can be determined by the server 102, or any other suitable device, by detecting the participants that have joined the same communication session and those of which are located close to each other.

Examples of the disclosure can also be used with systems 100 that transmit video streams with the audio signals 200, 202. The video streams can be presented to the participants on the display of a client device 104 or by any other suitable means. In such examples, it can be beneficial for the participant to have the virtual position of the audio signal 200, 202 coming from a given client device 104 to be the same as the direction at which the video signal coming from that client device 104 is presented on the display. For example, if video from the other client device 104 is visible at the left side of the display the corresponding audio signals 200, 202 would also be positioned to the left. In examples where a spatial audio signal 202 is received from a client device 104 with a video stream, the width of the processed audio sector can be related to the width of the embedded video visible on the display.

FIG. 9 schematically illustrates an apparatus 900 that could be used to implement examples of the disclosure. The apparatus 900 comprises at least one processor 902 and at least one memory 904. It is to be appreciated that the apparatus 900 could comprise additional components that are not shown in FIG. 9. The apparatus 900 could be provided within a server 102 or a client device 102 or within any suitable device.

In the example of FIG. 9 the apparatus 900 comprises a processing apparatus. The apparatus 900 can be configured to process audio data. The apparatus 900 can be configured to process audio data for use in teleconferencing or for any other suitable purpose.

In the example of FIG. 9 the implementation of the apparatus 900 can be as processing circuitry. In some examples the apparatus 900 can be implemented in hardware alone, have certain aspects in software including firmware alone or can be a combination of hardware and software (including firmware).

As illustrated in FIG. 9 the apparatus 900 can be implemented using instructions that enable hardware functionality, for example, by using executable instructions of a computer program 906 in a general-purpose or special-purpose processor 902 that can be stored on a computer readable storage medium (disk, memory etc.) to be executed by such a processor 902.

The processor 902 is configured to read from and write to the memory 904. The processor 902 can also comprise an output interface via which data and/or commands are output by the processor 902 and an input interface via which data and/or commands are input to the processor 902.

The memory 904 is configured to store a computer program 906 comprising computer program instructions (computer program code 908) that controls the operation of the apparatus 900 when loaded into the processor 902. The computer program instructions, of the computer program 906, provide the logic and routines that enables the apparatus 900 to perform the methods described herein. The processor 902 by reading the memory 904 is able to load and execute the computer program 906.

The apparatus 900 therefore comprises: at least one processor 902; and at least one memory 904 storing instructions that, when executed by the at least one processor 902, cause an apparatus 900 at least to perform:
receiving 300 multiple audio signals wherein the multiple audio signals comprise at least one spatial audio signal;
obtaining 302 information relating to activity of sound sources for at least for the at least one spatial audio signal; and
enabling 304 spatial processing of the at least one spatial audio signal based, at least in part, on the obtained activity information wherein the spatial processing controls the positioning of the sound sources according to the obtained activity information.

As illustrated in FIG. 9 the computer program 906 can arrive at the apparatus 900 via any suitable delivery mechanism 910. The delivery mechanism 910 can be, for example, a machine-readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 906. The delivery mechanism can be a signal configured to reliably transfer the computer program 906. The apparatus 900 can propagate or transmit the computer program 906 as a computer data signal. In some examples the computer program 906 can be transmitted to the apparatus 900 using a wireless protocol such as Bluetooth, Bluetooth Low Energy, Bluetooth Smart, 6LoWPan (IP_{V}6 over low power personal area networks) ZigBee, ANT+, near field communication (NFC), Radio frequency identification, wireless local area network (wireless LAN) or any other suitable protocol.

The computer program 906 can comprise computer program instructions for causing an apparatus 900 to perform at least the following or for performing at least the following:
receiving 300 multiple audio signals wherein the multiple audio signals comprise at least one spatial audio signal;
obtaining 302 information relating to activity of sound sources for at least for the at least one spatial audio signal; and
enabling 304 spatial processing of the at least one spatial audio signal based, at least in part, on the obtained activity information wherein the spatial processing controls the positioning of the sound sources according to the obtained activity information.

The computer program instructions can be comprised in a computer program 906, a non-transitory computer readable medium, a computer program product, a machine readable medium. In some but not necessarily all examples, the computer program instructions can be distributed over more than one computer program 906.

Although the memory 904 is illustrated as a single component/circuitry it can be implemented as one or more separate components/circuitry some or all of which can be integrated/removable and/or can provide permanent/semi-permanent/dynamic/cached storage.

Although the processor 902 is illustrated as a single component/circuitry it can be implemented as one or more separate components/circuitry some or all of which can be integrated/removable. The processor 902 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the Figs. can represent steps in a method and/or sections of code in the computer program 906. The illustration of a particular order to the blocks does not necessarily imply that there is a required or preferred order for the blocks and the order and arrangement of the block can be varied. Furthermore, it can be possible for some blocks to be omitted.

In the example of FIG. 9 the apparatus 900 is shown as a single entity. In other examples the apparatus 900 could be provided a plurality of different entities that could be distributed within a cloud or other suitable network.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus for spatial audio communication, comprising:
at least one processor; and
at least one memory storing instructions that, when executed with the at least one processor, cause the apparatus at least to:
receive multiple audio signals wherein the multiple audio signals comprise at least one spatial audio signal;
obtain information relating to activity of sound sources for at least for the at least one spatial audio signal; and
enable spatial processing of the at least one spatial audio signal based, at least in part, on the obtained activity information wherein the spatial processing controls the positioning of the sound sources according to the obtained activity information.

2. The apparatus as claimed in claim 1, wherein the instructions, when executed with the at least one processor, cause the spatial processing to control the positioning of one or more active sources.

3. The apparatus as claimed in claim 2, wherein the activity information is based on at least one of:
position of active sources in an audio signal;
number of active sources in an audio signal; or
amount of activity of active sources in an audio signal.

4. The apparatus as claimed in claim 1, wherein the instructions, when executed with the at least one processor, cause the apparatus to at least one of reposition the at least one spatial audio signal or resize the at least one spatial audio signal.

5. The apparatus as claimed in claim 1, wherein the instructions, when executed with the at least one processor, cause the apparatus to resize at least one spatial audio signal so that an audio signal with more activity from sound sources has a larger size than an audio signal with less activity from sound sources.

6. The apparatus as claimed in claim 1, wherein the instructions, when executed with the at least one processor, cause the apparatus to apply a weighting factor to one or more spatial audio signals and resize the spatial audio signals based on the weighting factor wherein the weighting factor is based, at least in part, on the activity information.

7. The apparatus as claimed in claim 1, wherein a resizing of the spatial audio signal changes an angular span of the audio signal.

8. The apparatus as claimed in claim 1, wherein a repositioning of the spatial audio signal changes a distance of the audio signal.

9. The apparatus as claimed in claim 1, wherein the instructions, when executed with the at least one processor, cause the apparatus to reposition the obtained at least one spatial audio signal so that a first audio signal is positioned in a first direction and a second audio signal is positioned in a second direction.

10. The apparatus as claimed in claim 1, wherein the instructions, when executed with the at least one processor, cause the apparatus to reposition the obtained at least one spatial audio signal so that an audio signal with more activity from sound sources is in a more prominent position than an audio signal with less activity from sound sources.

11. The apparatus as claimed in claim 1, wherein the instructions, when executed with the at least one processor, cause the apparatus to combine the multiple audio signals after the spatial processing.

12. The apparatus as claimed in claim 1, wherein the multiple audio signals comprise at least one mono audio signal.

13. The apparatus as claimed in claim 12, wherein the instructions, when executed with the at least one processor, cause the apparatus to assign a position to the at least one mono audio signal.

14. The apparatus as claimed in claim 1, wherein the multiple audio signals comprise a first audio signal captured from a first audio scene and a second audio signal captured from a second audio scene.

15. The apparatus as claimed in claim 1, wherein the spatial audio signal comprises at least one of:
stereo;
multi-channel;
ambisonics; or
parametric spatial audio.

16. The apparatus as claimed in claim 1, wherein the multiple audio signals are received with multiple channels.

17. (canceled)

18. A method, comprising:
receiving multiple audio signals wherein the multiple audio signals comprise at least one spatial audio signal;
obtaining information relating to activity of sound sources for at least for the at least one spatial audio signal; and
enabling spatial processing of the at least one spatial audio signal based, at least in part, on the obtained activity information wherein the spatial processing controls the positioning of the sound sources according to the obtained activity information.

19. A non-transitory program storage device readable with an apparatus, tangibly embodying a program of instructions executable with the apparatus for performing operations, the operations comprising:
receiving multiple audio signals wherein the multiple audio signals comprise at least one spatial audio signal;
obtaining information relating to activity of sound sources for at least for the at least one spatial audio signal; and
enabling spatial processing of the at least one spatial audio signal based, at least in part, on the obtained activity information wherein the spatial processing controls the positioning of the sound sources according to the obtained activity information.

20. The method as claimed in claim 18, wherein the spatial processing controls the positioning of one or more active sources.

21. The method as claimed in claim 18, wherein the spatial processing comprises at least one of: repositioning the at least one spatial audio signal; or resizing the at least one spatial audio signal.
